(19) United States
(12) Patent Application Publication
(10) Pub. No.: US 2009/0266798 A1
(43) Pub. Date: Oct. 29, 2009

(54) RESISTANCE WELDING HEAD AND METHOD FOR MANUFACTURING THE SAME

(76) Inventor: Shitong Yang, Guangdong (CN)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/158,565

(22) PCT Filed: Dec. 14, 2006
(86) PCT No.: PCT/CN2006/003404

§ 371 Date: Nov. 17, 2008

(30) Foreign Application Priority Data
Dec. 23, 2005 (CN) 200510121259.2

(51) Int. Cl. B23K 11/30; H01C 17/00

(52) U.S. Cl. 219/119; 29/611

(57) ABSTRACT

The present invention relates to a resistance welding head for use in production of electronic components with various kinds of small coils. The resistance welding head has a welding head tip and two opposite electrodes integrally extending from two sides of the welding head tip. A separating slot is defined between the two electrodes. Two ends of the two electrodes afar from the welding head tip are insulatively secured to each other via an insulating adhesive suitably received in the separating slot, so as to avoid potential crack at the welding head tip.

### BACKGROUND OF THE INVENTION

1. Field of the Invention

The present invention relates to a resistance welding head and a method for manufacturing the same, which can be used for production of electronic components with various kinds of small coils in electronics industry or micro-electronics industry, so as to facilitate welding lead-out wire contacts of enameled wires via one side welding.

2. Description of Related Art

In conventional art, two electrodes of a resistance welding head are typically arranged as two separated parts, that is, the two electrodes are independent to each other. In welding, a component to be welded is set between the two electrodes and welding force is applied. When the welding force achieves a predetermined value, the power is turned on. Current from the two electrodes flows through the component to be welded to generate resistance heat for welding the component.

Referring to Chinese patent No. CN 01114808.8 issued on Feb. 25, 2004, two electrodes of the resistance welding head are secured to each other via an insulating pastern and two tips of the electrodes are in ohmic contact with each other.

However, the resistance welding head as disclosed in the prior art at least has the following disadvantage. Electrodes of the resistance welding head are arranged as two separated parts and the current can not flow through the insulating layer of the enameled wire and, therefore, the resistance welding head with two independent electrodes can not be used for directly welding enameled wires.

Additionally, during each welding operation, electric sparks may be generated at the ohmic contact portion around the electrode tips. In continuous welding operation, electric sparks will be continuously generated at the ohmic contact portion, which will inevitably lead to structure change of the ohmic contact portion of the welding head and even disappearance of the ohmic contact. Consequently, resistance welding head having previously described structure is not steady and does not have a long service life.

### SUMMARY OF THE INVENTION

One object of the present invention is to overcome the shortcomings as set forth previously and provide a resistance welding head for spot welding enameled wires in production of various of electronic components.

According to one embodiment of the present invention, a resistance welding head includes a welding head tip and two opposite electrodes integrally extending from two sides of the welding head tip. A separating slot is defined between the two electrodes.

The electrodes of the resistance welding head according to one embodiment the present invention are integrally formed. When the welding current flows through the welding head tip, high temperature is generated thereon to strip off the insulating layer of the enameled wire. After the insulating layer is striped off, the current flows through the metal wire to be welded, thereby realizing direct welding of the enameled wire. Moreover, in the welding process, the welding head tip does not generate electric sparks. Therefore, the resistance welding head has a steady structure and a long service life.

According to a further advantageous embodiment of the present invention, two ends of the two electrodes afar from the welding head tip are insulatively secured to each other, which not only can avoid potential crack of the resistance welding head around the welding head tip but also can reduce the size of the welding head tip.

In accordance with another embodiment of the present invention, a method for manufacturing a resistance welding head includes the steps of:

processing electrode material to a predetermined post;

defining a separating slot along the longitudinal axis of the post, the separating slot extending from one end of the post towards the other end of the post to configure the post as a welding head tip and two opposite electrodes integrally extending from two sides of the welding head tip; and

processing the welding head tip to a predetermined shape.

Compared with the prior art, the method for manufacturing the resistance welding head in accordance with one embodiment of the present invention has at least the following advantages. The two electrodes, the welding head tip situated between the two electrodes and the separating slot between the two electrodes can be configured via a single manufacturing step and from a single post, thereby simplifying the manufacturing process and saving material.

According to a further advantageous embodiment of present invention, in the method for manufacturing the resistance welding head, the two ends of the two electrodes afar from the welding head tip are insulatively secured to each other, which can not only stabilize the structure of the resistance welding head but also avoid potential crack around the welding head tip as well as reduce the size of the welding head tip.

Other advantages and novel features will be drawn from the following detailed description of embodiments with the attached drawings, in which:

### BRIEF DESCRIPTION OF THE DRAWINGS

FIG. 1 is a structural schematic view of a resistance welding head according to one embodiment of the present invention, wherein the two electrodes of the resistance welding head are both semi-cylinders, and part 1-1 shows a front view and part 1-2 shows a side view;

FIG. 2 is a structural schematic view of a resistance welding head according to another embodiment of the present invention, wherein two electrodes of the resistance welding head are both slices, and part 2-1 shows a front view and part 2-2 shows a side view;

FIG. 3 is a schematic view of an insulatively securing manner for the two electrodes of the resistance welding head of FIG. 1, wherein two ends of the electrodes afar from the welding head tip are secured to each other via an insulating pastern suitably disposed in the separating slot between the two electrodes;

FIG. 4 is a schematic view of an insulatively securing manner for the two electrodes of the resistance welding head of FIG. 2, wherein two ends of the electrodes afar from the welding head tip are secured to each other via an insulating pastern suitably disposed in the separating slot between the two electrodes.

FIG. 5 is a schematic view of another insulatively securing manner for the two electrodes of the resistance welding head shown in FIG. 1, wherein two ends of the two electrodes afar from the welding head tip are insulatively secured to each other via an insulating pad suitably set in the separating slot and an insulating sleeve correspondingly set around the electrodes.

FIG. 6 is a schematic view of another insulatively securing manner for the two electrodes of the resistance welding head shown in FIG. 2, wherein two ends of the two electrodes afar from the welding head tip are insulatively secured to each other via an insulating pad suitably set in the separating slot and an insulating sleeve correspondingly set around the electrodes.

FIG. 7 is a schematic view of yet another insulatively securing manner for the two electrodes of the resistance welding head shown in FIG. 1, wherein each of the two electrodes defines a mounting hole in communication with the separating slot at one end thereof afar from the welding head tip, and the electrodes are secured to each other via insert connection.

FIG. 8 is a schematic view of yet another insulatively securing manner for the two electrodes of the resistance welding head shown in FIG. 2, wherein each of the two electrodes defines a mounting hole in communication with the separating slot at one end thereof afar from the welding head tip, and the electrodes are secured to each other via insert connection.

### DETAILED DESCRIPTION OF THE INVENTION

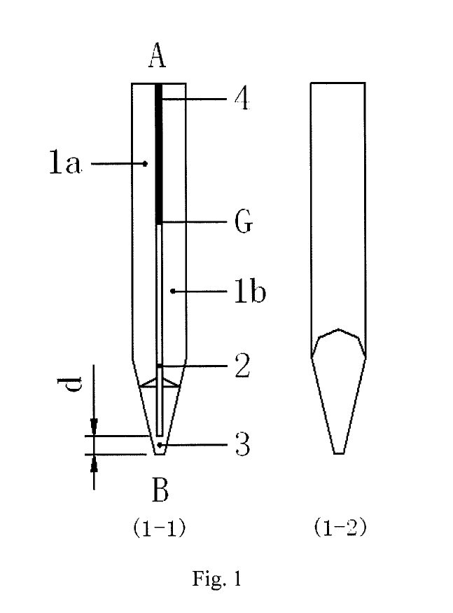

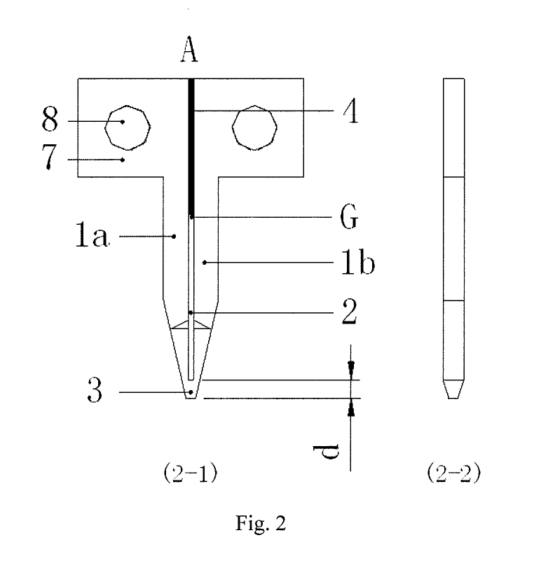

Referring to FIGS. 1 and 2, a resistance welding head in accordance with one embodiment of the present invention includes a welding head tip 3 and a pair of parallel electrodes 1a, 1b integrally extending upwardly from two sides of the welding head tip 3. A separating slot 2 is defined between the two electrodes 1a, 1b.

In electronics industry or microelectronics industry, it is desirable to weld the enameled wires to the pad from which the contact is led out for production of electronic components. For facilitating the welding operation of the wielding head tip (i.e., the work surface of the welding head) on the pad, the work surface of the resistance welding head must have a smaller area than that of the pad. Generally, the area of the pad in actual use is very small, for instance about 1×1 mm². Therefore, it would be desirable to reduce the corresponding area of the work surface of the resistance welding head. Furthermore, to ensure that the large current flowing through the resistance welding head can produce temperature high enough for completing the welding at the welding head tip 3, it would be desirable to ensure that a longitudinal section area of the welding head tip 3 is smaller than a cross sectional area of the two electrodes 1a, 1b of the resistance welding head. The resistance welding head is generally made from tungsten and molybdenum metal materials which are hard and brittle. Therefore, if the electrodes 1a, 1b are connected to each other only via the welding head tip 3, the welding head is possible to crack near the junction between the electrodes 1a, 1b and the welding head tip 3.

In order to prevent the resistance welding head from cracking at the welding head tip 3, two ends of the two electrodes 1a, 1b of the resistance welding head afar from the welding head tip 3 are insulatively connected to each other. The embodiments of the insulatively securing manners are described in detail as below.

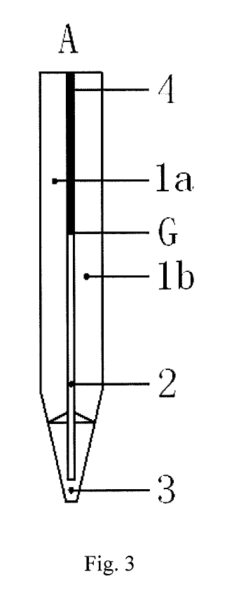

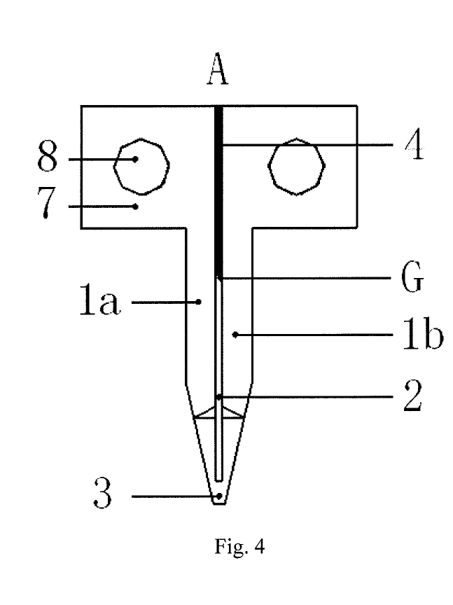

Referring to FIGS. 3 and 4, the two electrodes 1a, 1b of the resistance welding head can be insulatively secured to each other via conglutination. For example, a paste adhesive 4 (such as insulating pastern) is directly filled into the separating slot 2. The two electrodes 1a, 1b are insulatively secured to each other stably when the insulating pastern solidifies. According to another embodiment of the present invention, insulating adhesive, such as insulating pastern, is coated on surfaces of an insulating pad 4 to be bonded to the electrodes 1a, 1b. The insulating pad 4 with insulating pastern coated thereon is suitably filled in the separating slot 2. Thus, the two electrodes 1a, 1b are insulatively secured to each other via the filling of the insulating pad 4 and the affixing of the insulating pastern.

In the above embodiments, the insulating pastern is preferably thermosetting adhesive, such as chipbonder3609 by Loctite Corp. The chipbonder3609 is thermosetting adhesive of one-component epoxy resin having a red paste aspect, a specific gravity of 1.38, a viscosity of 380 pa×s at 25° C., a thermosetting temperature of 130-150° C. in about 30 minutes, an adhesion strength about 50 N/mm2, an insulation impedance coefficient of 1.8×1017Ω·cm and a dielectric constant of 3.8×100 KHz. The chipbonder3609 has high heat resistance (Tg=148° C.) and excellent electric characteristics. Therefore, in solidified state, it can also maintain good adhesion strength at the temperature of 100° C., which can completely meet the operating requirements of being filled into the separating slot 2 as an insulating layer for bonding.

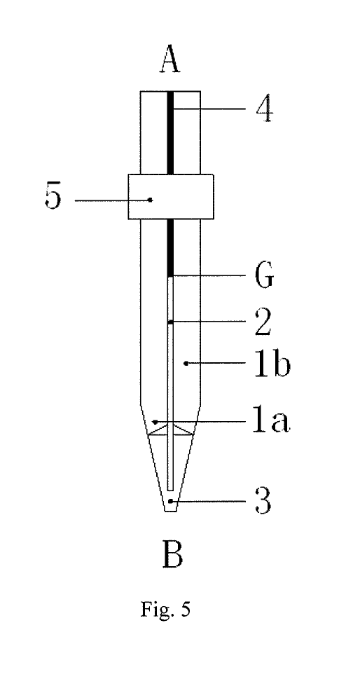

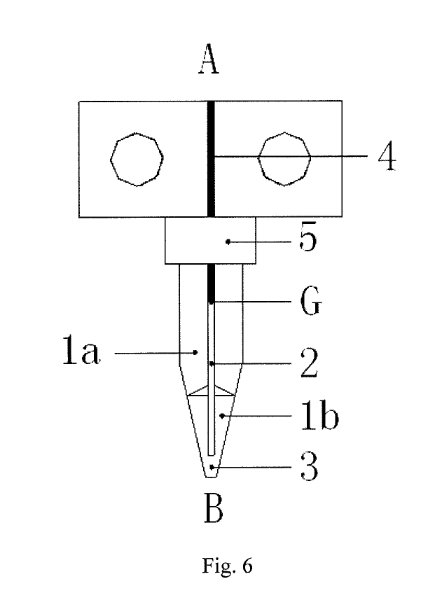

Referring to FIGS. 5 and 6, the two electrodes 1a, 1b of the resistance welding head can be insulatively secured to each other from exterior. One or more insulating pads 4 are filled into the separating slot 2 between the electrodes 1a, 1b. An insulating sleeve 5 corresponding to the insulating pads 4 in the separating slot 2 is set around the periphery of the electrodes 1a, 1b. Therefore, the two electrodes 1a, 1b are insulatively secured to each other. It is to be noted that both the insulating pads 4 and the sleeve 5 preferably can withstand a temperature of about 10020 C.

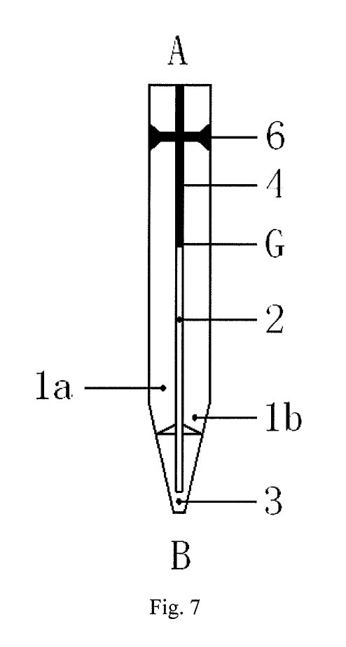

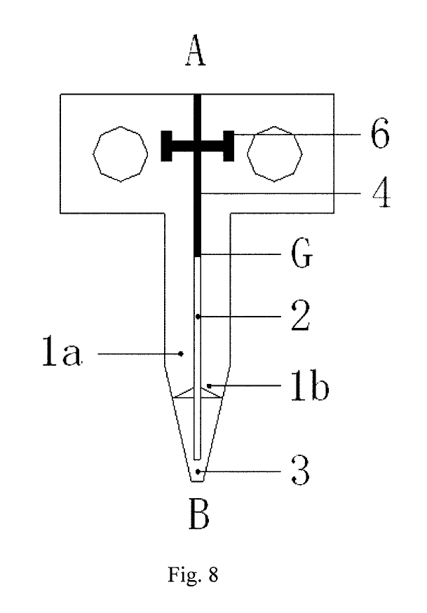

Referring to FIGS. 7 and 8, the two electrodes 1a, 1b of the resistance welding head can be insulatively secured to each other via insert connection. The two electrodes 1a, 1b each defines a mounting hole 6 perpendicularly communicated to the separating slot 2 at one end thereof afar from the welding head tip 3. Insulators are filled into the separating slot 2 and the mounting holes 6. The insulator may be paste, and the electrodes 1a, 1b can be insulatively secured to each other when the insulator is hardened. In another embodiment of the invention, the insulators formed by insulating materials may have a fixed shape and are filled into the separating slot 2 and the mounting holes 6 to secure the two electrodes 1a, 1b to each other. It is to be noted that the insulators according to the foregoing embodiments are need to have the capability of withstanding a temperature of about 100° C. Additionally, the mounting holes 6 can also be configured as I-shaped, dumbbell-shaped, or other shapes. And also, each electrode 1a, 1b can define one or more mounting holes 6.

The fact that two ends of the two electrodes 1a, 1b of the resistance welding head afar from the welding head tip 3 are insulatively secured to each other according to the present invention can reduce or avoid the possible crack of the resistance welding head at the welding head tip 3. Therefore, the welding head tip 3 can be made smaller, so as to facilitate its use on the pads of electronic components from which the contact is led out.

The resistance welding head according to the present invention is preferably made from tungsten and molybdenum metal materials with high strength, high hardness and high temperature resistance, for instance, the molybdenum metal, the tungsten metal, the silver-tungsten, the tungsten-copper, the tungsten carbide and other materials known in the art.

According to one embodiment of the present invention, the two electrodes 1a, 1b of the resistance welding head are both semi-cylinders, slices, or posts each having a cross-section of other shapes, such as semi-square or semi-ellipse.

Referring to FIG. 1, when the two electrodes 1a, 1b are semi-cylinder shaped, the resistance welding head can be easily hold by a clamp. In one embodiment of the invention, the external diameter of each electrode 1a, 1b may be about 3 mm to 5 mm, the total length of the welding head is about 25 mm to 40 mm, the width of the separating slot 2 between the two electrodes 1a, 1b is about 0.05 mm to 0.20 mm, and the thickness of the welding head tip 3 is about 0.2 mm to 1.0 mm. According to actual requirements, the work surface of the welding head tip 3 can be processed to a proper shape, such as square shaped, wedge shaped or circular-arc shaped.

Referring specifically to FIG. 2, when the two electrodes 1a, 1b are slices, each of the electrodes 1a, 1b may forms an installing portion 7 on one end thereof afar from the welding head tip 3. A through hole 8 is defined in each installing portion 7. The electrodes 1a, 1b are installed to an output electrode metal block of the welding machine by screws. Each electrode 1a, 1b has an upper wide portion and a lower thin portion. The installing portion 7 is situated in the wide portion. Each slice has a thickness of about 1 mm to 3 mm and a length of about 15 mm to 25 mm. A diameter of each through hole is about Φ3 mm to Φ5 mm. The distance between the two through holes is about 8 mm to 12 mm. The width of the separating slot 2 between the two electrodes 1a, 1b is about 0.05 mm to 0.20 mm. The thickness of the welding head tip 3 is about 0.2 mm to 1.0 mm. The work surface of the welding head tip 3 can be processed to a proper shape in view of actual requirements, such as square shaped, wedge shaped or circular-arc shaped.

As previously discussed, in the welding process, the current density flowing through the welding head tip 3 of the resistance welding head is very high, sometimes higher than 1000 A, and the temperature generated at the welding head tip 3 is also very high (may be higher than 1500° C.). Therefore, the insulation between the two electrodes 1a, 1b and the heat dissipation of the welding head tip 3 have to be dealt with in a proper manner.

As to the insulation between the two electrodes 1a, 1b, the resistance welding head according to the present invention is mainly used for welding enameled wires to the lead-out contacts. A diameter of the enameled wire is generally less than Φ50 mm. Thus, a low-voltage and large-current resistance welding machine having output voltage lower than 5V is typically adopted as the power supply. Accordingly, the insulation requirement between the two electrodes 1a, 1b is not very strict. Since air has good insulating and heat dissipating property, it is unnecessary to additionally fill a layer of insulating material between the two electrodes 1a, 1b adjacent to the welding head tip 3. The width of the separating slot 2 is calculated in accordance with the air's insulating property. Insulation withstanding strength of the air is 3000V-4000V/mm, that is, when the voltage is 5V, the width of the separating slot 2 only needs larger than 1/600 mm to 1/800 mm. That is to say, even though the width of the separating slot 2 is very small, the insulation requirements between the two electrodes 1a, 1b still can be met.

As to the heat dissipation at high-temperature, the high temperature is mainly generated at the work surface of the resistance welding head, that is, the welding head tip 3 connecting the two electrodes 1a, 1b. According to the resistance welding head of one embodiment of the present invention, the actual dimension of the welding head tip 3 is very small. Therefore, the heat can be dissipated very smoothly by increasing the size of the clamp for holding the two electrodes 1a, 1b or increasing the volume of the output electrode metal block and its heat radiating area. If necessary, other heat dissipating manners, for instance air-cooling or water-cooling can also be used for maintaining the temperature of the metal of the clamp in a desirable range (generally under 100° C.), which can considerably reduce requirements to the high temperature resistance of the insulating pads 4.

Referring to FIGS. 1 to 8, a method for manufacturing the resistance welding head in accordance with to the present invention will now be described in detail. First, a molybdenum bar AB of Φ3×30 mm is provided. A separating slot 2 is defined in the molybdenum bar AB along its longitudinal axis. The separating slot 2 starts at an end A of the molybdenum bar AB and terminates at a position 0.6 mm afar from an end B of the molybdenum bar AB. The separating slot 2 has a width of about 0.20 mm and a length of about 29.5 mm. Accordingly, the molybdenum bar AB is configured as two substantially parallel electrodes 1a, 1b connected to each other at the end B. A work surface symmetric with respect to the longitudinal axis of the molybdenum bar AB is processed to a proper sharp at the end B, for instance square shaped, wedge shaped, circular-arc shaped or other shapes. According to the depicted embodiment, area of the work surface of the end B is a little smaller than 1×1 mm². One or more insulating pads 4 having a shape corresponding to the separating slot 2, such as mica slice are selected. Paste thermosetting adhesive is coated on the surfaces of one or more insulating pads 4 which will be combined to the electrodes. The one or more insulating pads 4 are filled into an upper segment AG of the separating slot 2. Thereafter, the two electrodes 1a, 1b are insulatively secured to each other when the adhesive is solidified.

In the method mentioned above, the one or more insulating pads 4 can not only be filled into a segment of the separating slot 2 afar from the welding head tip 3, but also be filled into a majority of the separating slot 2.

In the manufacturing method for the resistance welding head according to the present invention, the longitudinal section area of the welding head tip 3 is smaller than the cross sectional area of the two electrodes 1a, 1b.

In the manufacturing method for the resistance welding head according to the present invention, the resistance welding head is preferably made from tungsten and molybdenum metal materials having high strength, high hardness and high temperature resistance, such as molybdenum metal, tungsten metal, silver-tungsten, tungsten-copper, and tungsten carbide.

It is to be noted that the two electrodes 1a, 1b can be insulatively secured to each other in various manners, such as directly filling adhesive, e.g. insulating pastern in the separating slot 2, or coating insulating pastern on surfaces of one or more insulating pads 4 and filling one or more insulating pads 4 with insulating pastern coated thereon in the separating slot 2, or suitably filling one or more insulating pads 4 into the separating slot 2 and hitching the insulating sleeve 5 on the periphery of the electrodes 1a, 1b at a position corresponding to the insulating pads 4 filled in the separating slot 2. Also, the mounting holes 6 may be defined in the ends of the two electrodes 1a, 1b afar from the welding head tip 3, and the two electrodes 1a, 1b are secured to each other by insulators filled in the mounting holes 6.

The resistance welding head manufactured by the method according to the present invention can be installed to a welding machine as disclosed in Chinese patent No. CN 01114785.7 titled “Spot welding machine for directly welding enameled wires”. A normal enameled wire of Φ0.12 mm and a phosphor-copper plate having a thickness of 0.12 mm are selected as components. Three welding parameters are set as: output pulse level 1.30V, output pulse time 12 ms and welding force 0.7 kg. It is shown that in relevant experimental the welding life of the resistance welding head is more than 20,000 solder joints with excellent welding effect.

Many modifications and other embodiments of the invention set forth herein will come to mind to one ordinary skill in the art to which this invention pertains having the benefit of the teachings presented in the foregoing descriptions and the associated drawings. Therefore, it is to be understood that the invention is not to be limited to the specific embodiments disclosed herein and that modifications and other embodiments are intended to be included within the scope of the appended claims. Although specific terms are employed herein, they are used in a generic and descriptive sense only and not for the purposes of limitation.

1. A resistance welding head, comprising:
a welding head tip; and
two opposite electrodes integrally extending from two sides of the welding head tip, respectively,
wherein a separating slot is defined between the two electrodes and two ends of the electrodes afar from the welding head tip are insulatively secured to each other.

2. The resistance welding head of claim 1, wherein an insulating pastern is suitably disposed in the separating slot for insulatively securing the two electrodes.

3. The resistance welding head of claim 1, wherein an insulating pad coated with adhesive on the surfaces thereof is suitably disposed in the separating slot for insulatively securing the two electrodes.

4. The resistance welding head of claim 1, wherein the separating slot is compliantly filled with an insulating pad and an insulating sleeve is correspondingly set around the two electrodes.

5. The resistance welding head of claim 1, wherein the two electrodes each defines at least one mounting hole in communication with the separating slot d at one end thereof afar from the welding head tip, the two electrodes are insulatively secured to each other via insert connection.

6. The resistance welding head of claim 1, wherein the welding head is made from tungsten and molybdenum metal materials having high strength, high hardness and high temperature resistance.

7. The resistance welding head of claim 1, wherein a longitudinal section area of the welding head tip has a smaller size than a cross section area of the two electrodes.

8. The resistance welding head of claim 1, wherein both of the two electrodes are semi-cylinders.

9. The resistance welding head of claim 1, wherein both of the two electrodes are slices.

10. The resistance welding head of claim 9, wherein each of the two electrodes is formed with an installing portion defining a through hole at one end thereof afar from the welding head tip, and the electrodes are respectively installed to an output electrode metal block of a welding machine by screws.

11. A method for manufacturing a resistance welding head, comprising the steps of:
1) processing electrode material to a predetermined post;
2) defining a separating slot along longitudinal axis of the post, the separating slot extending from one end of the post to a proper position afar from the other end of the post, so as to configure the post as a welding head tip and two opposite electrodes integrally extending from two sides of the welding head tip; and
3) processing the welding head tip to a predetermined shape.

12. The method for manufacturing the resistance welding head of claim 11, further comprising the step of insulatively securing two ends of the two electrodes afar from the welding head tip to each other.

13. The method for manufacturing the resistance welding head of claim 11, wherein the two electrodes are insulatively secured to each other via suitably filling an insulating pastern in the separating slot.

14. The method for manufacturing the resistance welding head of claim 11, wherein the two electrodes are insulatively secured to each other via suitably filling insulating one or more pads coated with adhesive on the surfaces thereof in the separating slot.

15. The method for manufacturing the resistance welding head of claim 11, wherein the two electrodes are insulatively secured to each other via filling insulating pads in the separating slot and correspondingly hitching the periphery of the two electrodes with an insulating sleeve.

16. The method for manufacturing the resistance welding head of claim 11, wherein each of the two electrodes comprises at least one mounting hole in communication with the separating slot at one end thereof afar from the welding head tip, the two electrodes are insulatively secured to each other via insert connection.

17. The method for manufacturing the resistance welding head of claim 11, wherein a work surface of the welding head tip is configured as square shaped, wedge shaped, or circular-arc shaped.

18. The method for manufacturing the resistance welding head of claim 11, wherein a longitudinal cross section area of the welding head tip is smaller than a cross section area of the two electrodes.

19. The method for manufacturing the resistance welding head of claim 11, wherein the welding head is made from tungsten or molybdenum metal material having high strength, high hardness and high temperature resistance.
